(19) United States
(12) Patent Application Publication
(10) Pub. No.: US 2007/0223815 A1
(43) Pub. Date: Sep. 27, 2007

(54) Feature Weighted Medical Object Contouring Using Distance Coordinates

(75) Inventor: Sherif Makram-Ebeid, Dampierre (FR)

Correspondence Address: PHILIPS MEDICAL SYSTEMS;PHILIPS INTELLECTUAL PROPERTY & STANDARDS, P.O. BOX 3003, 22100 BOTHELL EVERETT HIGHWAY, BOTHELL, WA, 98041-3003, US

(73) Assignee: KONINKLIJKE PHILIPS ELECTRONICS N.V., EINDHOVEN (NL)

(21) Appl. No.: 11/574,124

(22) PCT Filed: Jul. 27, 2005
(86) PCT No.: PCT/IB05/52525

§ 371 Date: Feb. 22, 2007

(30) Foreign Application Priority Data
Jul. 27, 2005 (IB) PCT/IB05/52525
Sep. 2, 2004 (EP) 04300570.1

(51) Int. Cl. G06K 9/34

(52) U.S. Cl. 382/173

(57) ABSTRACT

A method for segmenting contours of objects in an image, comprising a first step of receiving an input image containing at least one object, said image comprising pixel data sets of at least two dimensions, a second step of selecting a reference point of said input image within the object, a third step of generating a coordinate map of a distance parameter between the pixels of said input image and said reference point, a fourth step of processing said input image to provide an edge-detected image from said input image, a fifth step of calculating at least one statistical moment of said distance parameter in relation to a pixel p of said input image, with weight factors depending on the edge-detected image and on a filter kernel defined on a window function centered on said pixel p, and a sixth step of analyzing said at least one statistical moment to evaluate whether said pixel p is within said object.

The present invention relates to image segmentation. More specifically, the present invention addresses an effective and simplified technique for identifying the boundaries of distinct, discrete objects depicted in digital images, particularly medical images.

Such segmentation technique, also known as contouring, processes a digital image to detect, classify, and enumerate discrete objects depicted therein. It consists in determining for objects within a region of interest (ROI) their contours, i.e. outline or boundary, which is useful, e.g., for the analysis of shape, form, size and motion of an object.

This represents a difficult problem because digital images generally lack sufficient information to constrain the possible solutions of the segmentation problem to a small set of solutions that includes the correct solution.

Image contouring finds a popular application in the field of medical images, particularly computed tomography (CT) images, x-ray images, magnetic resonance (MR) images, ultrasound images, and the like. It is highly desirable to accurately determine the contours of various anatomic objects (e.g. prostate, kidney, liver, pancreas, etc., or cavities such as ventricle, atrium, alveolus, etc.) that appear in such medical images. By accurately determining the boundary of such anatomic objects, the location of the anatomic object relative to its surroundings can be used for diagnosis or to plan and execute medical procedures such as surgery, radiotherapy treatment for cancer, etc.

Image segmentation operates on medical images in their digital form. A digital image of a target such as a part of the human body is a data set comprising an array of data elements, each data element having a numerical data value corresponding to a property of the target. The property can be measured by an imaging sensor at regular intervals throughout the field of view of the imaging sensor. It can also be computed according to a pixel grid based on projection data. The property to which the data values correspond may be the light intensity of black and white photography, the separate RGB components of a color image, the X-ray attenuation coefficient, the hydrogen content for MR, etc. Typically the image data set is an array of pixels, wherein each pixel has one or more values corresponding to intensity. The usefulness of digital images derives partly from their ability to be transformed and enhanced by computer programs so that meaning can be extracted therefrom.

Known contouring techniques are generally complex and hence require long computational times. Furthermore, most of them are general-purpose techniques designed to operate for a priori any kind of object shapes, and may thus have poor performance for some specific object types.

It has been shown that the overall shape of an object to be segmented can be used to simplify its segmentation. For a cardiac chamber for example (e.g. a 2D view of a left ventricle in CT, MR or ultrasound echo-cardiography), or any cavity shaped object, the use of polar coordinates (r, θ) has brought some interesting results. With the origin of coordinates r=0 set interactively by the user, algorithms are then used to find the best possible contour along the ventricle edges among all contours expressed in polar coordinates (r,θ). The user's choice of the coordinate origin can be modified by repeating the segmentation procedures so as to place the origin as close as possible to the centroid of the 2D cavity view. An example of such use of polar coordinates can be found in the paper “Constrained Contouring in the Polar Coordinates”, S. Revankar and D. Sher, Proceedings of the IEEE Conference on Computer Vision and Pattern Recognition, New-York, USA 15-17 June 1993, pp 688-689.

This approach still requires the use of the angle variable θ in the contour determination, and presents a certain degree of complexity.

It is an object of the present invention to provide a simplified segmentation method, requiring limited computational complexity in order to meet real time constraints in 2D and 3D. A further object of the invention is to provide a method of segmentation requiring the use of only one spatial coordinate.

Accordingly, the present invention provides a method according to claim 1, a computer program product according to claim 12 and an apparatus according to claim 13.

The invention takes advantage of a simple coordinate map using a distance parameter between a reference point and the image pixel p. The criterion proposed to determine whether a pixel is inside or outside the contour is based on the calculation of statistical moments of the distance parameter, using weighting factors depending on the edge-detected image. The weighting factors also depend on a filter kernel defined over a window function centered on the pixel. Computational time is therefore fairly limited, which makes the method well suited to real time constraints.

Other features and advantages of this invention will further appear in the hereafter description when considered in connection to the accompanying drawings, in which:

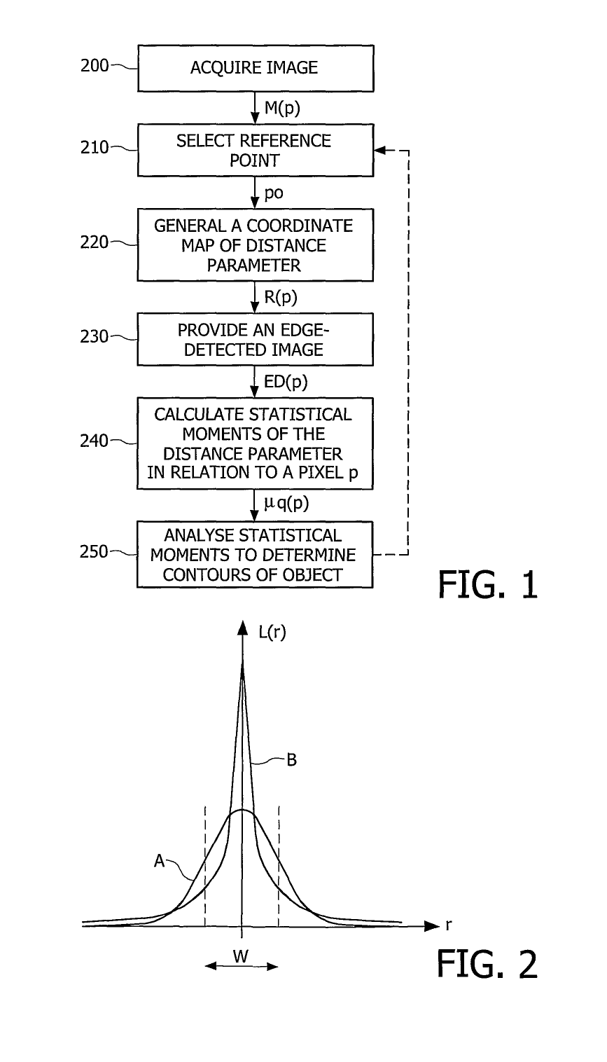

FIG. 1 is a general flow chart illustrating a method according to the invention;

FIG. 2 is a graph showing different filter kernels;

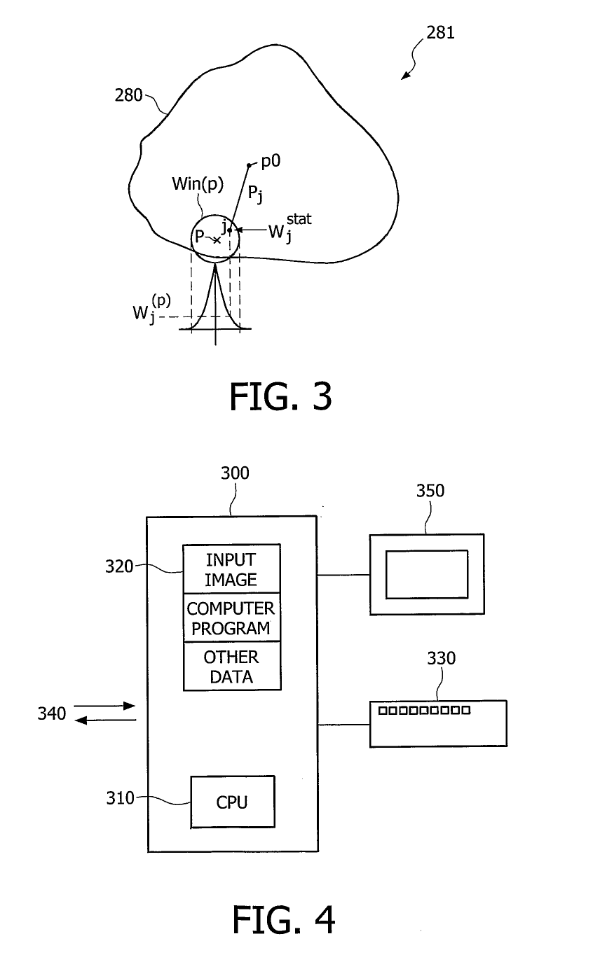

FIG. 3 is a diagram illustrating statistical data calculations using a filter kernel; and

FIG. 4 is a block diagram of a general purpose computer usable to carryout the invention.

The present invention deals with the segmentation of contours of an object in an image. Although the implementation of the invention is illustrated herein as a software implementation, it may also be implemented with a hardware component in, for example, a graphics card in a medical application computer system.

Referring now to the drawings, and more particularly to FIG. 1 thereof, a schematic diagram of the segmentation method according to the invention is shown.

The overall scheme includes an initial acquisition of a digital medical 2D or 3D image containing the object to be segmented in step 200. The acquired image can also be a sequence of 2D or 3D images, forming 2D+t or 3D+t data where time t is treated as an additional dimension. Step 200 may include the use of a file converter component to convert images from one file format to another is necessary. The resulting input image is called M(p) hereafter, p being a pixel index within the image. In the following, for ease of notation, an image and its constituent data will be referred to by the same name, hence M(p) both refers to the input image and the input data for pixel p.

In a second step 210, the selection of a reference point p0 is performed. In a preferred embodiment, this reference point is entered by the user, based on his/her assumptions of the object centroid, for instance by pointing on the expected centroid location on a graphic display showing the image by means of a mouse, a trackball device, a touchpad or a similar kind of pointing device, or by inputting the expected centroid coordinates with a keyboard or the like.

The reference point p0 can also be set automatically, using for example known mass detection schemes acting as initial detection algorithms which can return locations to be selected as possible reference points. A simple thresholding technique can also help determine a region of interest (ROI) where the reference point is selected. Such ROI can also be defined by the user.

In a third step 220, a coordinate map R(p) of a distance parameter between the pixels in the input image M(p) and the reference point p0 is defined. In order to determine the above-mentioned distance parameter, a reference frame is defined, the origin of which is the reference point p0 selected in the previous step 210. The choice of a proper reference frame is important as it can lead to a more efficient method. For cavity shaped object, the polar coordinate system is of a great convenience. All pixels of an image are referenced by their polar coordinates (r,θ), r is called the radius and is the distance from the origin, and θ is the angle of the radius r with respect to one of the system axes. Another possible choice is, for example, an ellipsoidal coordinate system, where r is replaced by an ellipsoidal radius ρ. It can also be interesting, as explained later on, to run the method iteratively and change the coordinate system as the segmentation progresses. The choice of a coordinate system can be either user-defined or automatic.

The coordinate map R(p) is then defined using the chosen reference frame. For each pixel p of the input image M, R(p) is defined as the distance parameter from said pixel p to the reference point p0 measured in the chosen coordinate system. The coordinate map consists of a matrix of the radii r in the case of a regular polar coordinate system or of the ellipsoidal radius p in the case of an ellipsoidal coordinate system. R(p) and M(p) are of the same size. The scheme can be generalized to any kind of distance parameter R(p), depending on the choice of coordinate system, as long as the chosen distance parameter has the topological properties of a distance. In the following description, R(p) will either refer to the coordinate map itself or the distance parameter for a given pixel p of the input image.

In a fourth step 230, the input image M(p) is processed to generate an edge-detected image ED(p) from the input image M(p). The edge-detected image ED(p) is created using known edge filtering techniques, such as the local variance method for example. The initial input data M(p) is subjected to edge detection so that its edges are detected to determine edge intensity data ED(p) for distinguishing the edge region of the object from other regions. Alternatively, the input image M(p) may be first subjected to sharpness and feature enhancement by a suitable technique to produce an image with enhanced sharpness. The edge-detected image ED(p) can be modified so as to set the edge intensity data to zero outside the region of interest (ROI), i.e. where the organ contour is not likely to be.

The pixel values ED(p) in the edge-detected image account for edge features in the ROI. They denote a feature saliency quantity which can be either the pixel intensity values, a local gradient in pixel intensity, or any suitable data related to the feature intensity in the image M(p).

In a fifth step 240, at least one statistical moment of the distance parameter R(p) in relation to a pixel p from the input image M(p) is calculated, with weight factors depending on the edge-detected image ED(p) and on a filter kernel L defined on a window function win(p) centered on the pixel p.

When collecting statistics, one can attribute a statistical weight factor Wᵢ to an observable data Sᵢ, describing its reliability, where i denotes a sample index. Statistical data can then be calculated such as the mean value M of the quantity Sᵢ, its variance σ², its standard deviation σ, or more generally its moments μ_{q} of order q=0, 1, 2, etc.:

$$\begin{matrix}{μ}_{q} = {\sum }_{i} {W}_{i} \cdot {S}_{i}^{q} & ( 1 ) \\ M = {μ}_{1} / {μ}_{0} & ( 2 ) \\ {σ}^{2} = {μ}_{2} / {μ}_{0} - {M}^{2} & ( 3 )\end{matrix}$$

This statistical approach can be applied to the objects of an image to be segmented. The observable data is then the distance parameter R(p). As for statistical weight factors, they are here defined in a neighborhood window win(p) of a pixel p over which statistical data, here statistical moments μ_{q}(p) of the distance parameter, are calculated. The weight factors are the product of:
a “statistical” weight ED(j) given by the edge-detected image. Here j is the index of a pixel within win(p). The statistical weight accounts for the presence or not of an edge around pixel p; and
a spatial or windowing weight w^{(p)}(j) whose support is the aforesaid neighborhood win(p) of pixel p. This windowing weight depends upon a filter kernel L, and is used to improve the “capture range”” as defined later on.

Hence:

$${μ}_{q} ( p ) = {\sum }_{j ∈ win ( p )} ED ( j ) \cdot {W}^{( p )} ( j ) \cdot {R ( j )}^{q} \qquad ( 4 )$$

For a given window win(p) centered on pixel p, μₚ(p) is a q order statistical moment of the distance parameter. The zero order statistical moment μ₀(p) of the distance parameter is the sum of the weight factors. μ₁(p) is the first order statistical moment of the distance parameter R(p). The arrays μ₁(P) and μ₀(p) are of the same dimension as R(p) and ED(p).

Based on (2), μ₁(p)/μ₀(p) is the mean value AR(p) of the distance parameter R(p). The second order statistical moment μ₂(p) of the distance parameter is usable to calculate the standard deviation SD(p) of the distance parameter R(p), or its variance SD(p)², based on (3):

$$S D ( p ) = \sqrt{( \frac{{μ}_{2}}{{μ}_{0}} ) - A {R ( p )}^{2}} \qquad ( 5 )$$

Equation (4) can be handled as a convolution of a linear low pass filter L having desired localization properties, with the function ED(p).R(p)^{q}:
μ_{q}(p)=L(ED(p).R(p)^{q}) (6)

W^{(p)}(j) in equation (1) is the kernel of above-mentioned filter L centered on pixel p. The kernel L can be of a Gaussian type for example as illustrated by curve A in FIG. 2. Alternatively, it may correspond to a specific isotropic filter kernel as illustrated by curve A in FIG. 2, and detailed later on. Beyond the window win(p), L is nil.

In the present invention, a coordinate map R(p) is defined (e.g. distances from a reference point), statistical data are determined as normalized correlations of the distance parameter using feature intensities and a filter kernel as statistical weights. An illustration of the statistics calculation can be seen in FIG. 3. An object 281 is to be segmented to determine its contour 280. A reference point p0 has been selected around the object centroid. The reference frame in this example is a polar coordinate frame. To calculate the statistical moment μ₁(p) for pixel p, a window win(p) is defined around pixel p (here the window is circular and p is its center), as well as the isotropic spatial kernel W^{(p)}(j) for all pixels j inside win(p). The kernel is maximum at p, and identical for all j pixels belonging to any circle centered on p. Beyond win(p), the kernel is nil.

In a sixth step 250, the at least one statistical moment in relation to a pixel p of the input image is analyzed to evaluated whether this pixel p is inside or outside the object to be segmented.

Contours of the object can be determined by comparing the distance parameter R(p) with the mean value AR(p) of the distance parameter R(p). When:

R(p)<AR(p)=μ₁(p)/μ₀(P), decision is made that pixel p is within the object;

R(p)>AR(p), decision is made that pixel p is the out of the object.

The boundary between the R(p)<AR(p) pixel domain and the R(p)>AR(p) pixel domain then defines the contour of the object.

Lack of resolution or the occurrence of noise in the initial image M(p) can lead to large standard deviations SD(p) in the calculated statistics. In a preferred embodiment, the difference R(p)−AR(p) is normalized by means of the standard deviation SD(p) to limit the impact of the data distribution:
ND(p)=(R(p)−AR(p))/SD(p) (7)

The normalized difference ND(p) represents a signed departure from the object edges, i.e. negative if pixel p is inside the object, and positive if outside. Since the sign of this ratio is the main clue for the segmentation method, we can use a squashing function to limit the variations to a given range such as [−1, 1]. One possibility is to define a “fuzzy segmentation function” using the error function erf( ) defined by:

$$erf ( x ) = \frac{2}{\sqrt{π}} {\int }_{0}^{x} {ⅇ}^{- {t}^{2}} ⅆ t \qquad ( 8 )$$

The fuzzy segmentation function yields:
FS(p)=erf(ND(p)) (9)

The likelihood that p is inside the object is the largest when FS(p) is close to −1, whereas the likelihood that p is outside the object is the largest when FS(p) is close to +1. Values of FS(p) around zero are classified with less certainty. To obtain a final segmentation, values of FS(p) are compared to threshold value T (that can be user-defined) between −1 and +1, below which all pixels p are classified as inside the organ boundary.

Techniques known in the art can be used to display the resulting segmented image. For example, displaying all pixels classified as inside the object to a certain gray level, while setting all pixels classified as outside said object to another gray level very different from the previous one so that the contour becomes evident.

The resulting organ segmentation can be used conventionally to determine a reliable estimate of its centroid that can provide a better origin of the reference point p0 (compared to the user-defined one, or the automatically selected one). The above procedure is then repeated from step 210 as seen in FIG. 1.

As mentioned before, the choice of the coordinate system can help improve the segmentation efficiency. An straightforward choice for cavity-shaped object is the polar system. The coordinate map is then a radius map, and the method according to the present invention does not require the use of the angle coordinate θ (for a 2D image) or angle coordinates θ, φ (for a 3D image), as only the radiuses are needed to perform the method, which is advantageous regarding computational complexity.

Distance parameters (with topological properties of a distance) other than the radius r can be used. For example, once a first segmentation is obtained, the segmented part of the object can be fitted with an ellipsoidal shape. The origin and main axis of this ellipsoidal shape can be used to define an ellipsoidal radius ρ to the center of the approximating ellipsoid defined by fitting an ellipsoid on the contour estimated in the first iteration. Each coordinate of this coordinate system is for example normalized using the length of the corresponding main axis. All the above procedure can then be performed with normalized radii ρ replacing r thereby generating segmentations less liable to artifacts that could be generated from a circular or spherical coordinate r. As for the polar coordinate system, there is no explicit use of the angles. This is an improvement over much more computational demanding (iterative) Mean Shift techniques.

Gathering statistical weights (from edge intensity data) replaces lengthy statistical iterations. In a further extension of the invention, any convex function representing prior knowledge on object shape can be used as a distance parameter.

Successive iterations of the method according to the present invention can include changes in the selected coordinate system to improve performance of the segmentation.

The overall computation complexity is low and allows the method to be performed in real-time.

Examples of filter kernels required for the statistical calculation can be seen in FIG. 2. An isotropic filter kernel L( r̅ₚ) ( r̅ₚ being the polar coordinate vector from filter kernel center p, of modulus rₚ) of a Gaussian type as in curve A and defined over the window win(p) centered around pixel p, with L( r̅ₚ)=0 beyond win(p) is a first suitable filter kernel for the present invention.

An isotropic filter combining local sharpness and large influence range is advantageous to compute the statistical moments μ₀(p), μ₁(p) and μ₂(p). Such kernel is illustrated by curve B. Curves A and B correspond to isotropic kernels having a central peak of average width W. It is seen that kernel B has a sharper peak than kernel A, and also a larger influence range because it decays more slowly at large distance form the center.

In order to reconcile local sharpness and large influence range, an improved isotropic filter kernel with kernel behaving like exp(−krₚ) is designed (using the modulus rₚ). Alternatively, we can design a kernel behaving like exp(−krₚ)/rₚⁿ, with n a positive integer, for large distances rₚ (from filter kernel center), instead of the classic exp(−r²/2σ²) behavior of Gaussian filters. Such kernels are sharp for small distances comparable to localization scale s of the features, and should follow the above laws for distances ranging from this scale s up to βs, where β is a parameter adapted to the image size, and is typically equal to 10. The value of k is also adapted to the desired localization scale s. As illustrated in FIG. 2, such a filter kernel is characterized with a sharp peak around its center and behaves like an inverse power law beyond its center region.

Such isotropic filter kernels L( r̅ₚ) can be computed:
as an approximation of a continuous distribution of Gaussian filters (for d-dimensional images, d an integer greater than 1),
using a set of Gaussians with different discrete kernel size σ,
each kernel is given a weight g(σ).

The resulting filter has a kernel equal to the weighted sum of Gaussian kernels:

$$L ( {r}_{p} ) = {\sum }_{σ} g ( σ ) \cdot \frac{{ⅇ}^{- {r}_{p}^{2} / {σ}^{2}}}{{σ}^{d}} \qquad ( 10 )$$

The spatial or windowing weights are then calculated using the above-mentioned expression for a pixel j of the window function win(p).

For computation efficiency, a multi-resolution pyramid is used with one or more single σ Gaussians (recursive filters with infinite impulse response (IIR)) for each resolution level.

As mentioned in the example of FIG. 3, the window win(p) associated to the spatial or windowing weights to calculate the statistical moments is preferably circular when using polar coordinates and elliptic when using ellipsoidal coordinates, centered in both instances on pixel p. The size of win(p) is determined according to the choice of filter kernel with L(j)=0 for all pixel j outside win(p). The size and shape can be the same for all pixels, but they can also vary depending, for example, on the density of features surrounding pixel p in the edge-detected image ED(p).

Other approaches (more computationally costly) can be used for such filter synthesis (e.g. Fourier domain, based on solving suitable partial differential equations, etc . . . ).

The invention also provides an apparatus for segmenting contours of objects in an image, and comprising acquisition means to receive an input image M containing at least one object, this image comprising pixel data sets of at least two dimensions, selecting means to select a reference point p0 in the object of the input image M, said point being either user-defined or set automatically by the selecting means. The apparatus according to the invention further comprises processing means to implement the above-disclosed method.

The invention may be implemented using a conventional general-purpose digital computer or micro-processor programmed to carry out the above-disclosed steps.

FIG. 4 is a block diagram of a computer system 300, in accordance to the present invention. Computer system 300 can comprise a CPU (central processing unit) 310, a memory 320, an input device 330, input/output transmission channels 340, and a display device 350. Other devices, as additional disk drives, memories, network connections, . . . , may be included but are not represented.

Memory 320 includes a source file containing the input image M, with objects to be segmented. Memory 320 can further include a computer program, meant to be executed by the CPU 310. This program comprises suitably encoded instructions to perform the above method. The input device is used to receive instructions from the user for example to select the reference point p0, to select a coordinate system, and/or run or not different stages or embodiments of the method. Input/output channels can be used to receive the input image M to be stored in the memory 320, as well as sending the segmented image (output image) to other apparatuses. The display device can be used to visualize the output image comprising the resulting segmented objects from the input image.

1. An apparatus for segmenting contours of objects in an image, comprising the steps of:
acquisition means for receiving an input image containing at least one object, said image comprising pixel data sets of at least two dimensions;
selection means to select a reference point within said object of the input image; and
processing means for:
generating a coordinate map of a distance parameter between the pixels of said input image and said reference point;
processing said input image to provide an edge-detected image from said input image;
calculating at least one statistical moment of said distance parameter in relation to a pixel p of said input image, with weight factors depending on the edge-detected image and on a filter kernel defined on a window function centered on said pixel p; and
analyzing said at least one statistical moment to evaluate whether said pixel p is within said object.

2. An apparatus according to claim 1, wherein said edge-detected image is defined in a region of interest of said input image, and located around said object.

3. An apparatus according to any one of the preceding claims, wherein said weight factors are local pixel intensity gradients in said input image.

4. An apparatus according to claim 1 or 2, wherein said weight factors are pixel intensity values in said input image.

5. An apparatus according to any one of the preceding claims, wherein the calculation of statistical moments by the processing means comprises calculating zero order and first order statistical moments of said distance parameter for said pixel p, and wherein the statistical moment analysis by the processing means comprises comparing the ratio of the first order statistical moment to the zero order statistical moment with the distance parameter between said pixel p and the reference point.

6. An apparatus according to claim 5, wherein the calculation of statistical moments by the processing means further comprises calculating a second order statistical moment of said distance parameter for said pixel p, and wherein the statistical moment analysis by the processing means comprises determining a standard deviation of said distance parameter based on the zero, first and second order statistical moments.

7. An apparatus according to claim 6, wherein the statistical moment analysis by the processing means further comprises:
calculating for said pixel p the difference between said distance parameter and said ratio of the first order statistical moment to the zero order statistical moment;
calculating for said pixel p a normalized difference by dividing said difference by said standard deviation of said distance parameter;
applying for said pixel p an error function to said normalized difference;
comparing said error function to a set threshold value between −1 and +1 to evaluate whether said pixel p is within said object.

8. An apparatus according to any one of the preceding claims, wherein said filter kernel is an isotropic low-pass filter kernel having a sharp peak around a center thereof and behaving like an inverse power law away from said center.

9. An apparatus according to claim 8, wherein said filter kernel is a sum of Gaussian filters having different kernel sizes σ, defined as:
L(r)=Σ_{σ}g(σ).exp(−r²/σ²)/σ^{d},
d being a dimension of the input image, r being a distance parameter from the filter kernel center, and each Gaussian filter having a respective weight g(σ).

10. An apparatus according to any one of the preceding claims, wherein said distance parameter from a pixel p to said reference point is a radius in a polar coordinate system centered on said reference point.

11. An apparatus according to one of claims 1 to 9, wherein said distance parameter from a pixel p to said reference point is an elliptical radius in an elliptical coordinate system centered on said reference point.

12. A method for segmenting contours of objects in an image, comprising the steps of:
receiving an input image containing at least one object, said image comprising pixel data sets of at least two dimensions;
selecting a reference point of said input image within the object;
generating a coordinate map of a distance parameter between the pixels of input image and said reference point;
processing said input image to provide an edge-detected image from said in image;
calculating at least one statistical moment of said distance parameter in rel to a pixel p of said input image, with weight factors depending on the edge-detected image and on a filter kernel defined on a window function centered said pixel p; and
analyzing said at least one statistical moment to evaluate whether said pixel is within said object.

13. A computer program product, to be executed in a processing unit of a computer system, comprising coded instructions to carry out a method according to claim 12 when run on the processing unit.
